(19) United States
(12) Patent Application Publication
(10) Pub. No.: US 2013/0236854 A1
(43) Pub. Date: Sep. 12, 2013

(54) CERAMIC ORAL IMPLANTS AND RELATED APPARATUS, SYSTEMS, AND METHODS

(71) Applicant: AMEDICA CORPORATION, Salt Lake City, UT (US)

(72) Inventors: Bryan J. McEntire, Sandy, UT (US); Ramaswamy Lakshminarayanan, West Jordan, UT (US)

(73) Assignee: AMEDICA CORPORATION, Salt Lake City, UT (US)

(21) Appl. No.: 13/789,408

(22) Filed: Mar. 7, 2013

Related U.S. Application Data
(60) Provisional application No. 61/607,878, filed on Mar. 7, 2012.

(51) Int. Cl. A61C 8/00

(52) U.S. Cl. CPC A61C 8/0013
USPC 433/173; 29/896.1

(57) ABSTRACT

Oral implants and related methods, systems, and apparatus. Some embodiments may comprise a silicon nitride bone anchor configured to be integrated with and affixed to alveolar bone of a patient's oral bone cavity. The bone anchor may comprise a core and an outer layer comprising a silicon nitride ceramic material. The outer layer may have a density less than a density of the core. An anchor abutment may be coupled with the bone anchor, and may be configured to protrude above epithelial tissue of the patient's oral cavity and provide a substrate for positioning and fixation of a dental component, such as a crown or bridge.

### RELATED APPLICATIONS

This application claims the benefit under 35 U.S.C. §119(e) of U.S. Provisional Patent Application No. 61/607,878 filed Mar. 7, 2012 and titled “COATED ORAL IMPLANTS AND RELATED APPARATUS, SYSTEMS, AND METHODS,” which application is incorporated herein by reference in its entirety.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 illustrates a dental implant at least partially comprising a ceramic material in accordance with one embodiment of the invention.

FIG. 2 illustrates another dental implant at least partially comprising a ceramic material and having a stepped density gradient in accordance with another embodiment of the invention.

FIG. 3 is a cross-sectional view of the embodiment depicted in FIG. 2.

### DETAILED DESCRIPTION

Embodiments described herein may be best understood by reference to the drawings, wherein like parts are designated by like numerals throughout. It will be readily understood that the components of the present disclosure, as generally described and illustrated in the drawings herein, could be arranged and designed in a wide variety of different configurations. Thus, the following more detailed description of the embodiments of the apparatus is not intended to limit the scope of the disclosure, but is merely representative of possible embodiments of the disclosure. In some cases, well-known structures, materials, or operations are not shown or described in detail.

Various embodiments of apparatus, methods, and systems are disclosed herein that relate to dental implants. In preferred embodiments, silicon nitride (Si3N4) ceramics are used in forming one or more of the components of the implant or other dental apparatus. Silicon nitride ceramics have tremendous flexural strength and fracture toughness. In some embodiments, such ceramics have been found to have a flexural strength greater than about 700 Mega-Pascal (MPa). Indeed, in some embodiments, the flexural strength of such ceramics have been measured at about 1,000 MPa. The fracture toughness of silicon nitride ceramics in some embodiments exceeds about 7 Mega-Pascal root meter (MPa·m½). Indeed, the fracture toughness of such materials in some embodiments is about 7-10 MPa·m½.

These characteristics are similar to, or better than, most of the common materials used for forming dental implants, such as titanium alloys, alumina, or zirconia ceramics. For example, silicon nitride is substantially stronger and tougher than alumina. Silicon nitride has similar strength and toughness characteristics to titanium, but has improved antibacterial properties, as discussed in greater detail below. Silicon nitride also provides other desirable characteristics, such as no low-temperature hydrothermal degradation (LTD), particularly relative to zirconia implants.

Due to one or more of the improved characteristics of silicon nitride mentioned above, or other improved characteristics, dental implants or other dental apparatus or systems formed using silicon nitride materials, in whole or in part, according to the present disclosure offer significant improvements upon existing dental implants. Various embodiments and implementations are contemplated. For example, dental implants used in connection with dental crowns, bridges, and the like may be formed, in whole or in part, from a silicon nitride material. In some embodiments, an implant may be provided that comprises a bone anchor, an anchor abutment, and dental component, such as a crown. The bone anchor may be configured to be integrated with and affixed to a patient's oral bone cavity on one side, and may provide a surface for integration with the anchor abutment on the other side. The anchor abutment may protrude above the epithelial tissue of the patient's oral cavity, and may provide a substrate for positioning and fixation of various dental components, such as crowns, bridges, and the like.

In some embodiments, the bone anchor itself may be made up of silicon nitride or a silicon nitride composite. In some embodiments, the anchor abutment, additionally or alternatively, may comprise a silicon nitride material. In some embodiments, the crown, bridge, or other similar dental component may also, or alternatively, be made up of silicon nitride. Other dental implants that may benefit from one or more of the teachings provided herein include brackets, braces, pins, wires, and fillings.

In some embodiments, the ceramic materials used to form one or more components of the implants described herein may comprise a doped silicon nitride. Examples of suitable silicon nitride materials are described in, for example, U.S. Pat. No. 6,881,229, titled “Metal Ceramic Composite Articulation,” which is incorporated by reference herein. In some embodiments, dopants such as alumina (Al2O3), yttria (Y2O3), magnesium oxide, and strontium oxide, can be processed to form a doped composition of silicon nitride. The dopant amount may be optimized to achieve the highest density and mechanical properties. In further embodiments, the biocompatible ceramic may have a flexural strength greater than about 800 MPa, and a toughness greater than about 9 MPa·m½. Flexural strength can be measured on standard 3-point bend specimens per American Society for Testing of Metals (ASTM) protocol method C-1161, and fracture toughness can be measured using single edge notched beam specimens per ASTM protocol method E399. In some embodiments, powders of silicon nitride may be used to form the ceramic implants, either alone or in combination with one or more of the dopants referenced above.

Other examples of suitable silicon nitride materials are described in U.S. Pat. No. 7,666,229 titled “Ceramic-Ceramic Articulation Surface Implants,” the entire contents of which are hereby incorporated by reference. Still other examples of suitable silicon nitride materials are described in U.S. Pat. No. 7,695,521 titled “Hip Prosthesis with Monoblock Ceramic Acetabular Cup,” the entire contents of which are also hereby incorporated by reference.

Infection is a leading cause of dental implant failure. Such infections can be very serious and can cause loss of supporting bone and/or damage to the protective periodontal tissues. Repair of an infected implant is often quite painful, expensive, and often unsuccessful. Despite current treatment protocols involving antibacterial agents, many dental implants are lost due to infection, and many patients suffering from such infections face long, painful, and difficult recoveries. Many of the embodiments provided herein may be useful to avoid such infections, and other similar infections associated with other oral implants, due to the presence of silicon nitride and silicon nitride composites.

Silicon nitride has been discovered to have unexpected antibacterial properties and increased bone formation properties. Indeed, it has been recently demonstrated that the adhesion and growth of bacteria on silicon nitride materials is substantially reduced with respect to other common dental implant materials, such as Titanium and polyether ether ketone (PEEK). It has also been demonstrated that silicon nitride materials provide significantly greater adsorption of vitronectin and fibronectin, which are proteins known to decrease bacteria function, than Titanium and PEEK. It is thought that these properties will be very useful in dental implants and other oral implants by significantly reducing the possibility of infection. This may be accomplished by, for example, preventing or disrupting bacterial formation on/in the implant and/or killing bacteria that have been transferred to the implant.

In some embodiments of dental implants, a bone anchor may be provided that is configured to be integrated with and affixed to alveolar bone of a patient's oral bone cavity. The bone anchor may comprise a core comprising a silicon nitride ceramic material and an outer layer comprising a silicon nitride ceramic material. The outer layer may have a density less than a density of the core to further facilitate oseointeg ration.

An anchor abutment may be coupled with the bone anchor, wherein the anchor abutment is configured to protrude above epithelial tissue of the patient's oral cavity and provide a substrate for positioning and fixation of a dental component, such as a bridge or crown.

Some embodiments may comprise one or more additional layers, such as an intermediate layer positioned between the core and the outer layer. Such layers may also comprise a silicon nitride ceramic material, and may vary in density. For example, the intermediate layer may have a density less than the density of the core, and the intermediate layer may have a density greater than the density of the outer layer. Some embodiments may be configured such that the outer layer has a density that varies from a maximum density adjacent to the core to a minimum density on a peripheral surface of the bone anchor. Some embodiments may further be configured such that the density of the outer layer varies continuously from the maximum density to the minimum density.

Some embodiments of oral implants may comprise a bone anchor configured to be integrated with and affixed to at least a portion of a patient's oral bone cavity. The bone anchor may comprise a silicon nitride ceramic material and an anchor abutment coupled with the bone anchor. A dental component may be affixed to the anchor abutment. In some embodiments, the anchor abutment may also comprise a silicon nitride ceramic material.

The silicon nitride ceramic material of one or more components of the implant may comprise a doped silicon nitride ceramic material. The doped silicon nitride ceramic material may comprise dopants selected from the group consisting of yttrium oxide, magnesium oxide, strontium oxide, aluminum oxide, and combinations thereof.

The bone anchor may comprise a core and an outer layer comprising a silicon nitride ceramic material, wherein the outer layer has a density less than a density of the core. The outer layer may comprise a roughened surface, such as a surface roughness greater than about 1,250 nm Ra, for example. Alternatively, the bone anchor may comprise an outer surface having a similar surface roughness without providing an outer layer.

In some implementations of methods for manufacturing an oral implant, the method may comprise forming a core of a bone anchor and forming one or more layers on the core. One or more such layers and/or the core of the implant may comprise a silicon nitride ceramic material. In some implementations, a first layer may comprise an outermost layer and may be configured for engagement with alveolar bone of a patient's oral bone cavity. In such implementations, the first layer may have a density less than a density of the core of the bone anchor.

In some implementations, a second layer may be formed on the core, wherein the second layer is positioned between the core and the first layer. The second layer may have a density less than the density of the core, and may have a density greater than the density of the first layer.

Some implementations may further comprise increasing a surface roughness of the core in order to enhance the antibacterial characteristics of the oral implant. In some such implementations, the step of increasing a surface roughness of the core may comprise increasing a surface roughness of the first layer. Alternatively, or additionally, the step of increasing a surface roughness of the core may comprise increasing a surface roughness of the core. Increasing a surface roughness of the core may be performed before the step of forming a first layer on the core such that a coating may be applied to the roughened core. Such coating may also, in some implementations, be surface roughened. Alternatively, a layer, such as a coating, may be applied without first performing a surface roughening. Such a roughening step may, if desired, be performed only on this outer layer/coating.

In some embodiments, the density of the silicon nitride material, or silicon nitride doped material, may vary throughout the implant, or throughout the portion of the implant made up of silicon nitride. For example, in embodiments including a bone anchor, as described in greater detail elsewhere herein, the outermost layer, or a portion of the outermost layer, may be more porous, or less dense, than the core or center of the implant. This may allow for bone to grow into or otherwise fuse with the less dense portion of the bone anchor portion of the implant, and the denser portion of the prosthesis can be wear-resistant, and may have a higher strength and/or toughness, for example.

In certain embodiments, one or more inner portions of the implant may have a relatively low porosity ceramic, and thus exhibit high density and high structural integrity generally consistent with, and generally mimicking the characteristics of, natural cortical bone. And, by contrast, one or more of the surface coatings, layers, or linings formed at an outer surface of the implant can exhibit a comparatively greater or higher porosity that is generally consistent with and generally mimics the characteristics of natural cancellous bone, such as the alveolar bone in an oral cavity. As a result, the higher porosity surface coating(s) or lining(s) can provide an effective bone ingrowth surface for achieving secure and stable bone ingrowth affixation of the ceramic portion of the implant (which, in some embodiments, comprises the entire implant) within the alveolar bone of a patient's oral bone cavity.

The specific material used for the bone ingrowth surface coating or lining may vary. In some embodiments, the porous material comprises a ceramic porous ingrowth surface material. Examples of such materials are disclosed in U.S. Pat. No. 6,846,327 titled “Radiolucent Bone Graft,” which is incorporated by reference herein. U.S. Pat. No. 6,846,327 discloses a ceramic bone graft component having relatively high flexural strength and relatively high toughness properties, yet defining first and second regions of comparatively lower and higher porosity to respectively mimic natural cortical and cancellous bone structures. These regions of different porosity may be unitarily constructed or otherwise integrated into a common or monolithic ceramic component having a variable porosity gradient. In some embodiments, the ceramic component may have a porosity gradient ranging from about 2% to about 80% by volume, with the higher porosity region having a porosity in the range of from about 30% to about 80% by volume.

In some embodiments, pores may be generated during the manufacturing process in order to create one or more layers of varying density. In some embodiments, the pore sizes may range from about 100 microns to about 500 microns. In some embodiments and implementations, such pores may be generated using a “poreformer,” which may comprise any suitable material that can be used to form pores in a ceramic material. In some embodiments, the poreformer may comprise an organic material that is volatile at firing temperatures such that, after firing of a portion of an oral implant, such as a core of the implant, pores are formed within a portion of a the implant, such as one or more layers of the implant, where the poreformer material was located prior to firing.

U.S. Pat. No. 6,846,327 also discloses a suitable alumina-zirconia ceramic material having a zirconia composition of about 10% to about 20% by volume, with either yttria stabilized zirconia (about 2.5 to about 5 mol % yttria in zirconia) or ceria stabilized zirconia (about 2.5 to about 15 mol % ceria in zirconia) for the zirconia phase. The resultant ceramic material exhibits a highly desirable combination of high flexural strength (e.g., greater than about 500 MPa) and high fracture toughness (e.g., greater than about 5 MPa·m½). Such alumina-zirconia based ceramic material may be employed in one or more portions, such as one or more layers, of the dental implant. By providing a dental implant, or another oral implant, that comprises silicon nitride, such implants may be better suited to avoid infections and also to increase bone ingrowth, particularly when porous silicon nitride materials are used.

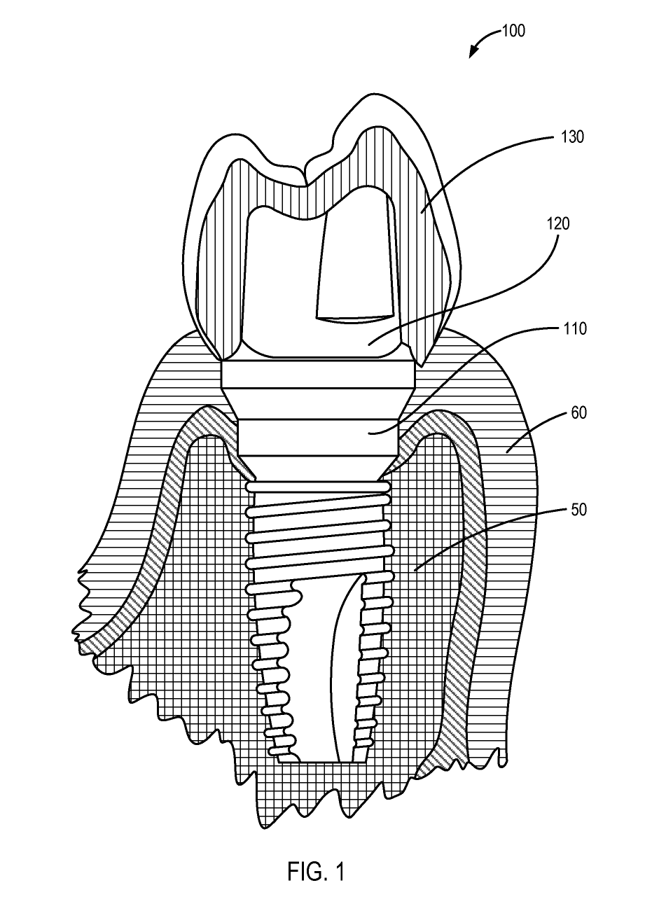

FIG. 1 illustrates an embodiment of the invention in the form of a dental implant 100. Dental implant 100 comprises a bone anchor 110 that has been positioned within a bone 50 in a patient's oral cavity. Dental implant 100 further comprises an abutment 120 that is positioned adjacent to the bone anchor 110. Abutment 120 is configured to secure a crown 130 thereto and extends through the patient's epithelial tissue 60. In some embodiments, bone anchor 110 may comprise one or more of the silicon nitride materials disclosed herein. In other embodiments, abutment 120 may also, or alternatively, be comprised of a silicon nitride or silicon nitride composite material. Of course, other embodiments are contemplated in which abutment 120 need not be included, or in which abutment 120 is integrally formed from the same silicon nitride material, or a similar composite material, that is used to form the bone anchor 110. In some such embodiments, a distinct border between abutment 120 and bone anchor 110 may not be apparent or present.

In some embodiments, it may be desirable to form some or all of the surface area of the implant that is to come in contact with biological tissue, such as bone, of a silicon nitride material or silicon nitride composite. For example, in the embodiment depicted in FIG. 1, the bone anchor 110 may be formed of such a material in order to reduce or eliminate bacterial colonization to thereby reduce the chance for infection. In some embodiments, the bone anchor 110 or another similar component may instead be coated with one or more silicon nitride coatings in order to take advantage of these antibacterial properties. As described in greater detail elsewhere herein, silicon nitride materials may also be useful for promoting growth of bone into the implant to stabilize and solidify the implant into the patient's natural bone structure(s).

Various methods may be used in order to apply a silicon nitride coating to a surface of a bone anchor or other dental implant. For example, coatings may be applied by way of a variety of processes known by those skilled in the art. Broadly, these may include, for example, physical vapor deposition (PVD) or chemical vapor deposition (CVD) processes, but, more specifically, can be low or high-temperature reactive CVD (i.e., LT-CVD, HT-CVD), DC or RF plasma-assisted CVD, DC or RF assisted PVD, balanced or unbalanced magnetron sputtering, ion-beam assisted deposition (IBAD), filtered cathodic arc deposition (FCAD), pulsed laser ablation and deposition (PLAD), electron cyclotron resonance CVD (ECR-CVD), or any other appropriate deposition method physical vapor deposition (PVD) or chemical vapor deposition (CVD) processes.

In some embodiments, one or more features may be provided to facilitate attachment of the bone anchor 110 to the bone 50. In the depicted embodiment, threads are provided such that the bone anchor 110 can be drilled or otherwise threaded into the bone 50. Threads and/or other attachment features and/or materials may also be used to couple the abutment 120 to the bone anchor 110, including adhesives, bone cement, screws, pins, raised features, etc. Similar features, components, and/or materials may be used to couple the crown 130 to the abutment 120, as those of skill in the art will appreciate.

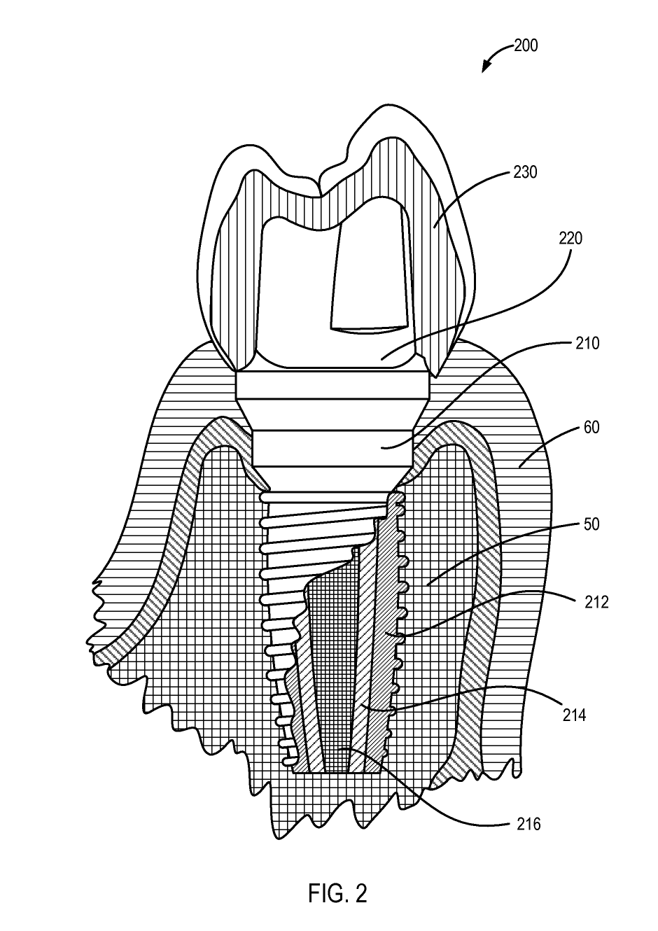

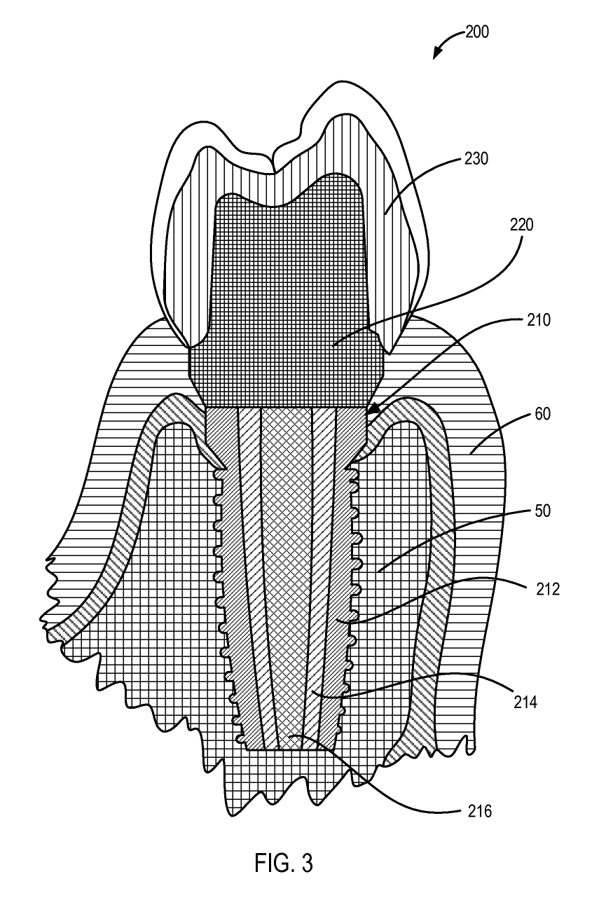

FIGS. 2 and 3 both depict a second embodiment of a dental implant 200 in accordance with certain aspects of the invention. Dental implant 200, like dental implant 100, comprises a bone anchor 210, an abutment 220, and a crown 230. However, unlike implant 100, bone anchor 210 of implant 200 comprises multiple layers of varying densities. Otherwise stated, bone anchor 210 comprises a stepped density gradient. More particularly, outer layer 212 is most porous and least dense, inner layer 216 is least porous and most dense, and middle layer 214 has a density in between that of the two layers within which it is positioned.

Although implant 200 is shown with three distinct layers, it is contemplated that, in other embodiments, the density of the bone anchor and/or another portion of the implant may vary continuously from the outside surface to the center, or may otherwise have a continuous, or substantially continuous, density gradient. As another alternative, one or more layers may be provided that vary in density continuously within that particular layer, but another layer or layers in the implant may be homogenous. For example, with reference to FIGS. 2 and 3, outer layer 212 may be non-homogenous and may vary in density continuously from the outside of outer layer 212 to the inside of outer layer 212, but layers 214 and 216 may be combined into a single, dense, homogenous layer (which differs from the embodiment depicted). Of course, additional layers may be used as desired for a particular implementation. In some embodiments, layers of decreased density may be formed by applying one or more coatings to the implant, or to a portion of the implant.

Providing a dental implant that varies in density may, in some implementations, facilitate incorporation of the implant into a patient's natural bone. For example, the less dense outer layer or layers of such implants may be configured so as to exhibit a comparatively greater or higher porosity that is generally consistent with, and generally mimics, the characteristics of natural cancellous bone. As a result, the higher porosity surface coating(s) or lining(s) can provide an effective bone ingrowth surface for achieving secure and stable bone ingrowth affixation of the ceramic portion of the implant (which, in some embodiments, comprises the entire implant) or of just a reduced density layer or portion of the ceramic portion of the implant.

Because, as discussed above, silicon nitride has been shown to possess both desirable antibacterial characteristics and to promote desirable bone attachment and ingrowth, it may be ideal for many oral implants, including the implant depicted in FIG. 2, and variations thereof. To further illustrate, in embodiments wherein at least one outer layer of the implant—such as outer layer 212—is made up, at least in part, of a porous silicon nitride material, bone material from the patient's jawbone may, over time, incorporate into the porous silicon nitride. Silicon nitride's antibacterial properties therefore may play a crucial and synergistic role with its bone ingrowth properties. This is because bacteria from the surface of the implant and/or the inside of the patient's mouth that otherwise may have caused an infection, and could potentially have been incorporated into the implant itself with the bone ingrowth, are likely to have been destroyed and/or prevented from colonization by the silicon nitride.

The desirable properties of silicon nitride materials discussed herein make it a attractive material for use in many other oral implants. For example, root canals often involve replacing the nerves and space within the root of a tooth with some sort of filling material. However, in a relatively high percentage of cases, despite the obturation of the root canal by such filling material, infection returns or otherwise sets in. This is often caused by the migration of bacteria and other infectious organisms from the mouth along the root canal cavity. And techniques for cleaning the root canal system are often less than fully successful in preventing such infections. It is therefore contemplated that embodiments of oral implants comprising fillings made up of silicon nitride materials may be useful to avoid infections. Because infections plague many other oral implants, the materials and other teachings provided herein may be similarly applied to any other such oral implant, including brackets, braces, pins, wires, cavity fillings, root canal fillings, and the like.

Some embodiments may comprise a combination of silicon nitride materials. For example, in some embodiments, bone anchor 210 may wholly comprise a silicon nitride ceramic material (as set forth above, in some embodiments in layers of varying densities) and abutment 220 may comprise another material coated with a silicon nitride coating. In some embodiments, it may be desirable to configure the oral implant such that any surface that will be expected to be in contact biological tissue will be made up of, or be coated with, a silicon nitride material so as to maximize the antibacterial characteristics of silicon nitride, as discussed elsewhere herein.

In one illustrative method for manufacturing a variable density ceramic implant or part of an implant, such as the bone anchor of the dental implant discussed above, a core may initially be formed. In some embodiments, the core may be formed of a relatively dense and non-porous ceramic material. In some embodiments, forming the core comprises compressing a ceramic powder into a solid part, such as via cold isostatic pressing (CIP). At the completion of this stage of the process, the core may be in a green state, and may then, in some embodiments, be combined with coating particles to form a monolithic structure.

The coating particles can be configured for joining to the core, and may be configured to form one or more portions of the multi-layer ceramic part that is less dense than the core. As further discussed below, in some embodiments the coating particles can be formed without compressing the coating particles (e.g., without CIP), whereas in other embodiments, CIP may be used in forming the coating particles. In various embodiments, the steps of forming the core and forming the particles may be performed in series (in either order) or, alternatively, in parallel. In some embodiments, at the completion of the particle formation stage, the coating particles may include a ceramic material that is in a powder state, such that the ceramic material has not yet been compacted. In other embodiments, at the completion of the particle formation stage, the coating particles may each comprise pre-compacted ceramic material. In either case, the coating particles may, in some embodiments, be in a green, or unfired, state at the completion of the particle formation stage, and may readily be joined with the core.

The core and the coating particles may be combined in an isopress mold. The core and the coating particles may be introduced into the isopress mold at the same time, or at approximately the same time. In other embodiments, the core may be formed within an isopress mold and may remain within the isopress mold while the coating particles are added to the isopress mold.

In some embodiments, the base and coating particles may be cold isostatic pressed so as to be joined to each other in a multi-layer part. For example, the isopress mold may be sealed and pressure may be applied thereto, either such that the pressure is gradually increased to an appropriate level or such that the desired pressure is applied in one step. At the completion of the isostatic pressing stage, the multi-layer part may be in a green state. In some embodiments, many different layers, each of varying density and/or composition, may be provided as desired in order to provide an implant or other ceramic product of the desired density gradient and/or of other desired properties. The green, multi-layer part may then be fired or otherwise finalized for use in any suitable manner.

In some embodiments, the process of forming the core of the implant may begin with weighing out a desired amount of ceramic powder, including any of the ceramic materials disclosed herein. The ceramic powder may then be introduced into an isopress mold. The mold may be of any suitable variety, and can be configured to yield the desired shape and configuration of the core. In various embodiments, the mold can comprise silicone and/or urethane. In some embodiments, the isopress mold may comprise a resilient material such that it can return, or substantially return, to an original shape after having been compressed via an isostatic pressing procedure.

The ceramic powder can be tightly packed into the isopress mold. For example, in some embodiments, a vibration plate or other vibration mechanism may be used to tightly pack the ceramic powder within the isopress mold. CIP of the mold and powder together may be used to compact the powder into a desired core shape, although in some embodiments, the core need not be fully compacted into its final size (when in the green state) at this stage. In particular, in some embodiments, the ceramic powder may initially be compacted into an intermediate, or partially compacted, core, after which CIP can be used to compress the core further at a later stage. In various embodiments, pressures used for the CIP may be within a range of from about 1,000 psi to about 10,000 psi; from about 2,500 psi to about 7,500 psi; from about 3,000 psi to about 6,000 psi; or from about 4,000 psi to about 5,000 psi. In some embodiments, such pressures may be no greater than about 4,000; 4,500; 5,000; 5,500; 6,000; 6,500; 7,000; 7,500; 8,000; 8,500; 9,000; 9,500; or 10,000 psi. In some embodiments, a pressure of about 4,500 psi is used. In various embodiments, a cold isostatic press that is rated at approximately 30,000 psi can be used for the CIP procedure.

In some embodiments and implementations, the coating particles may comprise poreformer particles, which may be coated with a ceramic powder. Such poreformer particles may be used to form pores in a ceramic material. In some embodiments, the poreformer particles may comprise an organic material that is volatile at firing temperatures such that, after firing of a portion of an oral implant, such as a core, pores are formed within the implant where the poreformer material was previously located.

In some embodiments and implementations, the poreformer may comprise one or more of polyethylene wax, microcrystalline cellulose, naphthalene, polyethylene glycol, and urea. In various embodiments, the poreformer material may be formed in the shape of beads (e.g., spheres), flakes, or chips. In other or further embodiments, the poreformer particles may have a maximum diameter of from about 50 microns to about 2,000 microns, from about 100 microns to about 1,500 microns, from about 200 microns to about 1,250 microns, from about 300 microns to about 1,000 microns, from about 500 microns to about 750 microns, from about 50 to about 500 microns, from about 500 microns to about 1,000 microns, or from about 1,000 microns to about 2,000 microns, or the poreformer particles may have a maximum diameter of no less than about 50, 100, 150, 200, 250, 300, 350, 500, 750, 1,000, or 1,500 microns, or no greater than about 50, 100, 150, 200, 250, 300, 350, 500, 750, 1,000, 1,500, or 2,000 microns.

In some embodiments and implementations, ceramic powder and poreformer material may be mixed together such that the poreformer is coated with the ceramic powder. Shaking or other agitation may be used to evenly or substantially evenly coat the poreformer. A quantity of ethanol or other suitable solvent may also be included in the mixture to facilitate the coating of the poreformer.

The coated poreformer may then be permitted to dry. For example, the ethanol or other solvent may be permitted to evaporate such that the ceramic powder remains firmly attached to the poreformer.

The ceramic-coated poreformer and excess ceramic powder may be screened, which may be used to remove excess ceramic powder from the poreformer material. The screen may also be used to obtain coating particles of a desired size. As described herein, such “coating particles” may comprise poreformer particles that are coated with ceramic powder.

As discussed above, silicon nitride has been discovered to possess unique antibacterial characteristics. In order to further enhance such characteristics, some embodiments and implementations may be configured to increase the surface roughness/surface area of one or more portions of the implant that are configured for oseointegration. For example, in some embodiments and implementations, a surface and/or coating may be roughened or textured to provide for increased surface area of the silicon nitride material/coating.

The surface roughness values disclosed herein may be calculated using the arithmetic average of the roughness profile (Ra). Polished silicon nitride surfaces may have a roughness of 20 nm Ra or less. However, as discussed in greater detail below, counterintuitively, the antibacterial properties of certain embodiments may be improved by roughening, rather than polishing, all or one or more portions of the surface of a silicon nitride ceramic or another similar ceramic oral implant. In some embodiments, a relatively rough surface may be created as part of the process of creating the material, such as during a firing stage, without further roughening or other surface engineering. However, in other embodiments, as discussed in greater detail below, the surface may be roughened to further increase the roughness beyond what would occur as a result of standard firing/curing alone.

Thus, in some embodiments, the surface roughness may be deliberately made to be greater than about 1,250 nm Ra. In some such embodiments, the surface roughness may be greater than about 1,500 nm Ra. In some such embodiments, the surface roughness may be greater than about 2,000 nm Ra. In some such embodiments, the surface roughness may be greater than about 3,000 nm Ra. In other embodiments, the surface roughness may be between about 500 nm Ra and about 5,000 nm Ra. In some such embodiments, the surface roughness may be between about 1,500 nm Ra and about 5,000 nm Ra. In some such embodiments, the surface roughness may be between about 2,000 nm Ra and about 5,000 nm Ra. In some such embodiments, the surface roughness may be between about 3,000 nm Ra and about 5,000 nm Ra.

In some embodiments, metallic, polymeric, or ceramic substrates may be pre-engineered with a surface texture onto which a silicon nitride coating may be applied. This texture can range from as low as about 5 nanometers up to about 5,000 nanometers or more in average surface roughness (Ra). Alternatively, as another embodiment, the surface texture of the silicon nitride coating itself can be increased, exclusive of the surface roughness of the substrate, to obtain a similar Ra range and resulting antibacterial effect. Some of the methods disclosed herein may therefore provide for engineering of the surface roughness of monolithic silicon nitride ceramic implants in order to improve their antibacterial performance, and other methods disclosed herein may provide for engineering the surface roughness of layers or coatings applied to substrates made up of any other suitable material available for use in biomedical implants, after which a suitable silicon nitride coating may be applied. Of course, in some implementations, surface engineering may be applied to both the substrate and the coating.

Increasing the surface roughness of the implant can be accomplished using any number of known methods by those skilled in the art, including micromachining, grinding, polishing, laser etching or texturing, sand or other abrasive blasting, chemical etching, thermal etching, plasma etching, and the like.

It will be understood by those having skill in the art that changes may be made to the details of the above-described embodiments without departing from the underlying principles presented herein. For example, any suitable combination of various embodiments, or the features thereof, is contemplated.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, inventive aspects lie in a combination of fewer than all features of any single foregoing disclosed embodiment. It will be apparent to those having skill in the art that changes may be made to the details of the above-described embodiments without departing from the underlying principles set forth herein.

1. A dental implant, comprising:
a bone anchor configured to be integrated with and affixed to alveolar bone of a patient's oral bone cavity, wherein the bone anchor comprises:
a core comprising a silicon nitride ceramic material; and
an outer layer comprising a silicon nitride ceramic material, wherein
the outer layer has a density less than a density of the core;
an anchor abutment coupled with the bone anchor, wherein the anchor abutment is configured to protrude above epithelial tissue of the patient's oral cavity and provide a substrate for positioning and fixation of a dental component; and
a dental component affixed to the anchor abutment.

2. The dental implant of claim 1, wherein the dental component comprises at least one of a crown and a bridge.

3. The dental implant of claim 1, further comprising an intermediate layer positioned between the core and the outer layer.

4. The dental implant of claim 3, wherein the intermediate layer has a density less than the density of the core, and wherein the intermediate layer has a density greater than the density of the outer layer.

5. The dental implant of claim 1, wherein the outer layer has a density that varies from a maximum density adjacent to the core to a minimum density on a peripheral surface of the bone anchor.

6. The dental implant of claim 5, wherein the density of the outer layer varies continuously from the maximum density to the minimum density.

7. An oral implant, comprising:
a bone anchor configured to be integrated with and affixed to at least a portion of a patient's oral bone cavity, wherein the bone anchor comprises a silicon nitride ceramic material; and
an anchor abutment coupled with the bone anchor, wherein the anchor abutment is configured to protrude above epithelial tissue of the patient's oral cavity, and wherein the anchor abutment is configured to provide a substrate for positioning and fixation of a dental component.

8. The oral implant of claim 7, wherein the anchor abutment comprises a silicon nitride ceramic material.

9. The oral implant of claim 7, further comprising a dental component coupled with the anchor abutment.

10. The oral implant of claim 9, wherein the dental component comprises a crown.

11. The oral implant of claim 7, wherein the silicon nitride ceramic material comprises a doped silicon nitride ceramic material.

12. The oral implant of claim 11, wherein the doped silicon nitride ceramic material comprises dopants selected from the group consisting of yttrium oxide, magnesium oxide, strontium oxide, aluminum oxide, and combinations thereof.

13. The oral implant of claim 7, wherein the bone anchor comprises:
a core; and
an outer layer comprising a silicon nitride ceramic material, wherein the outer layer has a density less than a density of the core.

14. The oral implant of claim 13, wherein the outer layer comprises a surface roughness greater than about 1,250 nm Ra.

15. The oral implant of claim 7, wherein the bone anchor comprises an outer surface having a surface roughness greater than about 1,250 nm Ra.

16. A method for manufacturing an oral implant, the method comprising the steps of:
forming a core of a bone anchor; and
forming a first layer on the core, wherein the first layer comprises a silicon nitride ceramic material, wherein the first layer comprises an outermost layer and is configured for engagement with alveolar bone of a patient's oral bone cavity, and wherein the first layer has a density less than a density of the core of the bone anchor.

17. The method of claim 16, wherein the core comprises a silicon nitride ceramic material.

18. The method of claim 16, further comprising forming a second layer on the core, wherein the second layer comprises a silicon nitride ceramic material, wherein the second layer is positioned between the core and the first layer, wherein the second layer has a density less than the density of the core, and wherein the second layer has a density greater than the density of the first layer.

19. The method of claim 16, further comprising increasing a surface roughness of the core in order to enhance the antibacterial characteristics of the oral implant.

20. The method of claim 19, wherein the step of increasing a surface roughness of the core comprises increasing a surface roughness of the first layer.

21. The method of claim 19, wherein the step of increasing a surface roughness of the core comprises increasing a surface roughness of the core.

22. The method of claim 21, wherein the first layer comprises a silicon nitride coating, and wherein the step of increasing a surface roughness of the core is performed before the step of forming a first layer on the core.
